(19) United States
(12) Patent Application Publication
(10) Pub. No.: US 2014/0212377 A1
(43) Pub. Date: Jul. 31, 2014

(54) SCENTED CAMO

(71) Applicant: Stewart Douglas Harden, Pooler, GA (US)

(72) Inventor: Stewart Douglas Harden, Pooler, GA (US)

(21) Appl. No.: 14/251,708

(22) Filed: Apr. 14, 2014

Related U.S. Application Data
(63) Continuation-in-part of application No. 13/425,511, filed on Mar. 21, 2012.

(51) Int. Cl. A01M 31/00; A01N 25/02

(52) U.S. Cl. CPC A01M 31/008; A01N 25/02
USPC 424/84

(57) ABSTRACT

A scented composition with concealment capabilities for use in game animal hunting. The method of use and the preparation of the scented composition are disclosed.

This application is a continuation-in-part application of U.S. Ser. No. 13/425,511, filed Mar. 21, 2012, currently pending.

### BACKGROUND OF THE INVENTION

The current invention is a game animal attractant composition that also has concealment capabilities. The prior art has many examples of materials used for attracting game animals. However, the applicant is unaware of any compositions that combine the instant materials provided by the method set forth herein, that includes the element of concealment. This discovery gives the current invention a greater utility over any other prior art discovery. The ability to have a game animal attractant composition that also provides concealment from the game that is sought after, elevates the current invention far beyond any other prior art.

### THE INVENTION

The present invention is a game animal attractant composition. This attractant composition comprises; olive oil and a scent compound attractive to a specific animal. The invention features an animal attractant composition where the scent compound is selected, but not limited to, the group consisting essentially of acorn oil, apple juice, peanut butter, deer estrus, dominant buck urine and fox urine.

In a preferred embodiment the product of this invention is an attractant composition that is formed into a solid insert. The solid insert can be inserted into a heating unit. Another embodiment of the present invention is where the attractant composition is formed for use with bait for attracting game animals. In another embodiment the product is an attractant composition formed to use on hunting equipment. In another embodiment the invention is an animal attractant composition formed into a lubricant for hunting equipment.

In another embodiment the product of this invention is an animal attractant composition and camouflage. The animal attractant composition is comprised of a cosmetic, olive oil, and scent oil attractive to game animals.

In still another embodiment the product of this invention is an animal attractant composition and camouflage where the base is a foundation cosmetic.

Foundation cosmetics consist of creams, liquids, pressed powders, loose powders, and the like.

In another embodiment the product of the present invention is an animal attractant composition and camouflage where the animal attractant composition and camouflage are colored.

In another embodiment the product of the invention is an animal attractant composition and camouflage where the color is selected from the group consisting of green, brown, gray, black and tan and mixtures of such colors.

In yet another embodiment the product of the current invention is an animal attractant composition where a method of preparing an animal attractant composition comprises providing olive oil; providing at least one animal scent compound and then combining the olive oil with scent compound. The method further requires stirring the olive oil and scent compound to form a mixture. This mixture is then, heated for a period, of time at less than 100° C. until the mixture homogenizes; thereafter cooling the homogeneous mixture whereby an animal attractant composition is obtained.

In another embodiment a method of preparing an animal attractant composition and camouflage of the present invention comprises providing olive oil with at least one scent compound that is attractive to the animal. The olive oil and scent compound are combined and then stirred to form a mixture. This mixture is then heated for a period of time at less than 100° C. until the mixture homogenizes. After cooling the homogeneous mixture it is mixed with a cosmetic foundation forming yet again a mixture until the mixture is homogeneous. Thereafter a homogeneous product that is an animal attractant composition and camouflage is obtained.

Finally, this invention deals with a method of attracting game animals using the compositions of this invention.

### DETAILED DESCRIPTION

In each of the previously mentioned embodiments the attractant composition and the camouflage are to peak interest in game animals with the desired outcome to provide an attract that has properties that involve concealment. The preferred embodiment, is the use of a combination of olive oil and one or more of a compound selected from acorn oil, apple juice, peanut butter, deer estrus, dominant buck urine and fox urine.

This product of the invention is can then be formed into a solid where the solid can be used in a heating unit to dispense the attractant composition into the air and bring the desired game animal into the area where the hunter is hunting.

Still another embodiment is the use of the solid product in combination with bait. The bait is then dispersed into an area that is to be hunted and the combination of the attractant composition and the bait will lure the targeted game into the area that is to be hunted by the hunter.

Another embodiment of the product is in the form that can be applied directly to hunting equipment. This can be done through direct application of the product of the invention to any or all of the equipment that the hunter carries afield. The product is applied to a bow, rifle, shotgun, crossbow, arrows, cartridges, shells, bolts, knives, clothing and footwear.

Another embodiment of the product is that it be configured to use as a lubricant for hunting equipment. In the form of a natural oil the product can be used to lubricate a gun or archery device in an attempt to maintain its proper working condition and at the same time having a secondary use as an attractant composition. Most weapons need lubrication to maintain proper operating performance. It has been discovered that a lubricant of this product enhances concealment of the user when afield. Most lubricants are formulated from petroleum based products which can be associated with human interaction to tip of the animal to the presence of a human nearby or at a minimum alert them that something is unusual.

Another embodiment is the product as an attractant composition combined with a camouflage. This product Is comprised of olive oil and a scent compound that is attractive to game animals or game that the hunter desires to attract. The following are such attractant composition compounds but are not limited to these provided, and any suitable scent compound for animal attraction is viable. The scent compound is selected from a group consisting but not limited to deer, elk, moose, rabbit, fowl, squirrel, antelope, fox, coyote, wolf and fish. Such scents compounds are commercially available. The combination provides the user with a scent attractant composition and the ability to conceal unconcealed portions of the hunter during hunting.

Another embodiment is to have the product as an attractant composition and a camouflage makeup in the form of a cosmetic for ease of application and removal.

Another embodiment is to have the product as an attractant composition and a camouflage makeup where it has color. The preferred embodiment has color as follows but is not limited to the specific colors suggested where any suitable color is acceptable; green, brown, gray, black and tan and mixtures thereof. The product is also available in a colorless format.

In yet another embodiment of the invention the method of product preparation provides olive oil, at least one animal scent compound combined to form a mixture. Then heating the mixture for a period of time at less than 100° C. until the mixture homogenizes. Then cooling the homogenous mixture whereby an animal attractant composition is obtained.

In another embodiment a method of preparing an animal attractant composition and camouflage by providing olive oil with at least one scent compound attractive to the animal. Combining and stirring to form a mixture and heating the mixture for a period of time at less than 100° C. until the mixture homogenizes and upon cooling forms a homogenized mixture. Then mixing into the mixture a cosmetic foundation until it homogenizes.

What is claimed is:

1. A method for attracting game animals., said method comprising;
A. providing a composition of matter that attracts game animals;
B. contacting said composition with a solid substrate;
C. placing said composition and solid substrate in a general area containing game animals.

2. A method as claimed in claim 1 wherein the composition of matter is comprised of olive oil and a scent compound selected from the group consisting essentially of one or more of;
a. acorn oil;
b. apple juice;
c. peanut butter;
d. deer estrus;
e. dominant buck urine, and,
f. fox urine.

3. A method as claimed in claim 2 wherein said composition is a solid.

4. A method as claimed in claim 1, wherein, in addition, said solid is heated in a heating unit.

5. A method as claimed in claim 2 wherein said composition is in the form of a bait specific for said game animal.

6. A method as claimed in claim 2 wherein the composition is in a form useable on hunting equipment.

7. A method as claimed in claim 2 wherein said composition is in the form of a lubricant for hunting equipment.

8. A method as claimed in claim 7, wherein the hunting equipment is hunting clothing.

9. A method as claimed in claim 2 wherein the composition is in a form for use on human skin.

10. A method as claimed in claim 9 wherein the composition used on said human skin is in the form of camouflage and is prepared by mixing said composition with a cosmetic material for human skin

11. The method as claimed in claim 10 wherein the cosmetic material is a foundation cosmetic.

12. The method as claimed in claim 11 wherein the foundation cosmetic is a cream.

13. The method as claimed in claim 11 wherein the foundation cosmetic is a liquid,

14. The method as claimed in claim 11 wherein the foundation cosmetic is a pressed powder.

15. The method as claimed in claim 11 wherein the foundation cosmetic is a loose powder,

16. A method as claimed in claim 10 wherein said composition is colored.

17. A method as claimed in claim 16 wherein said color is cosmetic and is selected from the group consisting of
ii. brown,
iii. gray,
iv. black,
v. fan, and,
vi. mixtures of i. to v.

18. A method of preparing a composition for use in the method of claim 1, said method comprising:
i. providing olive oil;
ii. providing at least one scent compound;
iii. combining i. with ii. with stirring to form a mixture;
iv. heating said mixture from iii. for a sufficient period of time at less than 100° C. until said mixture homogenizes;
v. thereafter cooling said homogeneous mixture whereby a scented composition is obtained.

19. A method of preparing a composition for use in the method of claim 10, said method comprising:
i. providing olive oil;
ii. providing at least one scent compound;
iii. combining i. with ii. with stirring to form a first mixture;
iv. heating said first mixture from iii. for a period of time at less than 100° C. until said first mixture homogenizes;
v. thereafter cooling said homogeneous first mixture;
vi. thereafter mixing a cosmetic foundation and color into said homogeneous first mixture to form a second mixture, until said second mixture is homogeneous whereby a camouflage composition is obtained.
